(19) United States
(12) Patent Application Publication
(10) Pub. No.: US 2010/0238300 A1
(43) Pub. Date: Sep. 23, 2010

(54) COLOR CONTROL APPARATUS, METHOD FOR CREATING COLOR CONTROL SYSTEM, AND METHOD FOR CREATING COLOR REPRODUCTION APPARATUS

(75) Inventor: Takayoshi KOJIMA, Azumino (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/724,875

(22) Filed: Mar. 16, 2010

(30) Foreign Application Priority Data
Mar. 23, 2009 (JP) 2009-070691

(51) Int. Cl. H04N 5/225; H04N 5/228

(52) U.S. Cl. 348/207.1; 348/222.1; 348/E05.024

(57) ABSTRACT

A color control apparatus includes an image-capture-data-obtaining unit that obtains image-capture data for a predetermined target by subjecting the predetermined target to image capturing; a colorimetric-data-obtaining unit that obtains colorimetric data for the predetermined target by subjecting the predetermined target to colorimetry; a first conversion unit that performs a first conversion including gradation conversion on the image-capture data and obtains first color data of a predetermined color space; a second conversion unit that performs a second conversion including gradation conversion on the colorimetric data and obtains second color data of a predetermined color space; and a modifying unit that, on the basis of color differences between the first color data and the second color data, performs optimization of the first conversion performed by the first conversion unit.

### BACKGROUND

1. Technical Field

The present invention relates to a color reproduction method for performing color reproduction on input data.

2. Related Art

To date, various methods for realizing color reproduction as desired by a user have been disclosed. For example, in JP-A-2005-101828, a technique is disclosed that realizes color reproduction by using color differences between image data obtained by subjecting a color chart, on which target colors have been recorded, to colorimetry using a colorimeter and image data of the color chart obtained by using an input device.

Furthermore, in order to increase the reproducibility and visibility of image data that has been subjected to color reproduction, the conversion system, which has been created by using the aforementioned color reproduction method, is corrected and colors of the conversion system to be actually used are set.

In the above-described color reproduction method of the related art, the created conversion system is corrected multiple times thereafter, and therefore differences between the colorimetric values and the corrected image data sometimes become large. Consequently, such a corrected conversion system has needed to be manually adjusted so as to minimize the differences.

When a conversion system has been adjusted manually, it has often been the case that the adjustment has relied upon the experience and the like of the operator and it has been difficult to set a conversion system that has both good accuracy and stability.

### SUMMARY

An advantage of some aspects of the invention is that it provides a color control apparatus, a method for creating a color control system and a method of creating a color reproduction apparatus that are capable of setting a conversion system that reproduces colors with good accuracy and with stability.

In order to solve the above-described problem, a color control apparatus according to an aspect of the invention includes an image-capture-data-obtaining unit that obtains image-capture data by subjecting a predetermined target to image capturing; a colorimetric-data-obtaining unit that obtains colorimetric data by subjecting the predetermined target to colorimetry; a first conversion unit that performs a first conversion including gradation conversion on the image-capture data and obtains first color data of a predetermined color space; a second conversion unit that performs a second conversion including gradation conversion on the colorimetric data and obtains second color data of the predetermined color space; and a modifying unit that, on the basis of color differences between the first color data and the second color data, performs optimization of the first conversion performed by the first conversion unit. In a case where it is determined that the first conversion, which has been modified, is not yet optimized, the modifying unit repeatedly performs a process of modifying the same first conversion and obtaining the first color data from the first conversion unit a plurality of times by using the modified first conversion until the first conversion is optimized.

In the color control apparatus according to the aspect of the invention having the above-described configuration, the first conversion unit performs the first conversion including gradation conversion on the image-capture data obtained by the image-capture-data-obtaining unit and obtains the first color data of the predetermined color space and the second conversion unit performs the second conversion including gradation conversion on the colorimetric data obtained by the predetermined target being subjected to colorimetry by the colorimetric-data-obtaining unit and obtains the second color data of the predetermined color space. Then, when it is determined that the first conversion is not yet optimized after being subjected to optimization by being modified by the modifying unit on the basis of the color differences between the first color data and the second color data, the modifying unit repeatedly performs a process of modifying the first conversion and obtaining the first color data from the first conversion unit a plurality of times by using the modified first conversion until the first conversion is optimized, whereby the conversion system for color reproduction is optimized.

Consequently, in the process of creating (optimizing) the color reproduction method, gradation conversion is carried out in advance and therefore compared with the case where gradation conversion is carried out after creating the color reproduction method, the amount by which the color reproduction method is required to be adjusted can be reduced. Furthermore, the above-described process can be completed within the color reproduction apparatus and a color reproduction method with improved color reproduction accuracy can be created, compared with the case where the color reproduction method is adjusted manually.

In addition, as an example of gradation of conversion, it is preferable that the same gradation conversion be performed by the first and second conversion units.

Furthermore, as an example of the first conversion, it is preferable that the modifying unit performs optimization of processing of correcting spectral characteristics in the first conversion.

In the color reproduction apparatus according to the aspect of the invention having the above-described configuration, in the conversion system that corrects the spectral characteristics of the image-capture data, the conversion system can be created while correcting gradation values.

Then, as an example of gradation conversion included in the optimization of the first conversion, the modifying unit subjects the gradation conversion to optimization.

The color reproduction apparatus according to the aspect of the invention having the above-described configuration, creates an optimal conversion system while performing gradation conversion with respect to the conversion system in order to correct the appearance and the like of image data and a conversion system can be created that takes gradation conversion into account.

Furthermore, as an example of a method with which the modifying unit performs optimization of the first conversion, it is preferable that the modifying unit modify the first conversion such that color differences between the first data and the second data are minimized. In the color reproduction apparatus according to the aspect of the invention and having the above-described configuration, a conversion system can be created such that color differences between image-capture data reproduced using the conversion system and colorimetric data are minimized.

Aspects of the invention are not limited to only apparatuses and can also be applied to methods for creating color control systems. Therefore, as another aspect of the invention, a method for creating a color reproduction system includes: obtaining image-capture data by subjecting a predetermined target to image capturing; obtaining colorimetric data by subjecting the predetermined target to colorimetry; performing a first conversion including gradation conversion on the image-capture data and obtaining first color data of a predetermined color space; performing a second conversion including gradation conversion on the colorimetric data and obtaining second color data of the predetermined color space; and performing modification by subjecting the first conversion to optimization on the basis of color differences between the first color data and the second color data. Here, in the case where it is determined that the first conversion, on which modification has been performed, is not yet optimized, in the modification, a process of modifying the first conversion and obtaining the first color data in the first conversion by using the modified first conversion is repeatedly performed a plurality of times until the first conversion is optimized.

Furthermore, aspects of the invention can also be applied to methods for creating color reproduction apparatuses. Accordingly, in a color-reproduction-apparatus-creating method, according to another aspect of the invention, for manufacturing a color reproduction apparatus that performs color reproduction on input data, the color reproduction apparatus includes: an image-capture-data-obtaining unit that obtains image-capture data by subjecting a predetermined target to image capturing; a colorimetric-data-obtaining unit that obtains colorimetric data by subjecting the predetermined target to colorimetry; a first conversion unit that performs a first conversion including gradation conversion on the image-capture data and obtains first color data of a predetermined color space; a second conversion unit that performs a second conversion including gradation conversion on the colorimetric data and obtains second color data of the predetermined color space; and a modifying unit that, on the basis of color differences between the first color data and the second color data, performs optimization of the first conversion performed by the first conversion unit. Here, in a case where it is determined that the first conversion, which has been modified, is not yet optimized, the modifying unit repeatedly performs a process of modifying the same first conversion and obtaining the first color data from the first conversion unit a plurality of times by using the modified first conversion until the first conversion is optimized.

### BRIEF DESCRIPTION OF THE DRAWINGS

The invention will be described with reference to the accompanying drawings, wherein like numbers reference like elements.

FIG. 1 is a structural block diagram for describing an example of a configuration of a color control apparatus 100.

FIG. 2 is an image for explaining a method of creating color reproduction parameters in the color reproduction device 100 according to an embodiment of the invention.

FIG. 3 is a flowchart describing processing performed by an operation unit 72 by using a program that creates color reproduction parameters.

FIG. 4 is a flowchart for explaining in detail the processing executed in step S120 of FIG. 3.

FIG. 5 is a diagram for explaining an example of contrast that has been subjected to conversion using a in LUT.

FIG. 6 is a flowchart for explaining in more detail the processing executed by the operation unit 72 in step S140 of FIG. 3.

FIG. 7 is an image for explaining the processing executed by the operation unit 72 by using a method of creating color reproduction parameters according to a second embodiment.

FIG. 8 is a flowchart explaining processing executed by the operation unit 72 by using a program that creates color reproduction parameters according to the second embodiment.

### DESCRIPTION OF EXEMPLARY EMBODIMENTS

Hereafter, embodiments of the invention will be described in the following order with reference to the drawings.

### 1. First Embodiment

1.1 Color control apparatus
1.2 Configuration of digital camera

### 1.3 Configuration of PC

1.4 Colorimeter and color chart
1.5 Method of creating color reproduction parameters

### 2. Second Embodiment

### 3. Other Embodiments

### 1. First Embodiment

### 1.1 Color Control Apparatus

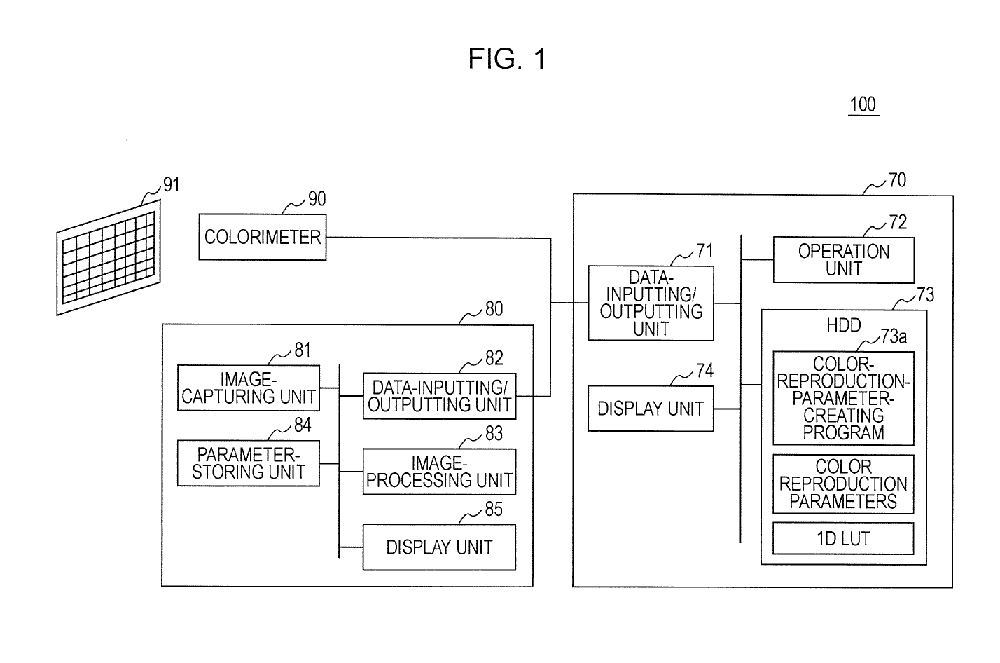

FIG. 1 is a structural block diagram for explaining an example of a configuration of a color control apparatus 100. Hereafter, an example will be described of a process of creating color reproduction parameters of a color reproduction device (image-capture-data-obtaining unit) such as a digital camera, performed in the color control apparatus 100 illustrated in FIG. 1.

By using a personal computer (hereafter “PC”) 70, the color control apparatus 100 creates color reproduction parameters, which a digital camera 80 uses to perform color reproduction, and outputs the created color reproduction parameters to the digital camera 80. At this time, the digital camera 80 performs image capturing on a color chart (target) 91 and outputs image-capture data, a colorimeter 90 subjects the color chart 91 to colorimetry and outputs colorimetric values, and then the PC 70 sets the color reproduction parameters by using the output image-capture data and colorimetric values.

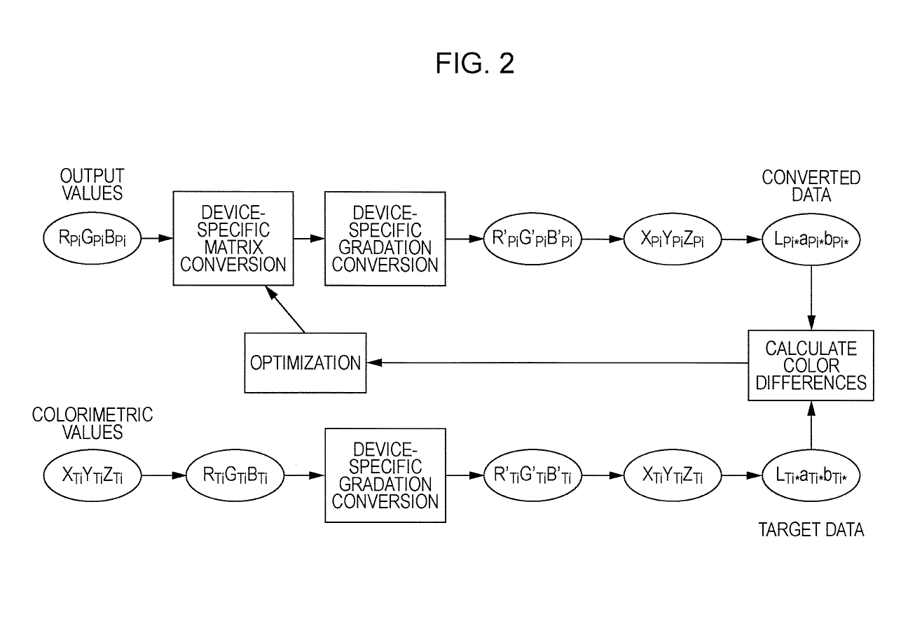

FIG. 2 is an image for explaining a method of creating color reproduction parameters in the color control apparatus 100 according to an embodiment of the invention. FIG. 2 illustrates processing performed within the PC 70.

First, the colorimetric values obtained by the color chart 91 being subjected to colorimetry with the colorimeter 90 and output values (image-capture data) obtained by the color chart 91 being subjected to image capturing with the digital camera 80 are input to the PC 70. Then, the PC 70 subjects the input output values to color processing and gradation conversion to convert the input output values into converted data of a uniform color space (L*a*b* color space), and subjects the colorimetric values to color processing and gradation conversion to convert the colorimetric values into target data of the uniform color space. Furthermore, the PC 70 calculates color differences between the output values and the colorimetric values and optimizes the color reproduction parameters on the basis of calculated color differences. Here, the target data is data representing target color values that have been set in the digital camera 80 in order to realize color reproduction characteristics as desired by a user.

In addition, as described above, in the color control apparatus 100, the output values and the colorimetric values, which are used to calculate the color differences, are subjected to gradation conversion and once the values have been corrected, they are used to optimize the color reproduction parameters. Usually, gradation conversion is performed after the color reproduction parameters have been optimized, but in the color control apparatus 100 according to the embodiment of the invention, it has been possible to reduce the number of processes necessary for readjustment of the parameters after creating the color reproduction parameters by performing the gradation conversion in the process of creating the color reproduction parameters. Furthermore, since adjustment of the color reproduction parameters can completed inside the PC 7, the color reproduction accuracy of the color reproduction parameters can be improved compared with the case where adjustment of the color reproduction parameters is performed manually. Next, the configuration of the color control apparatus 100 according to the embodiment of the invention will be described in detail.

### 1.2 Configuration of Digital Camera

The configuration of the digital camera 80 will now be described. The digital camera 80 includes an image-capturing unit 81, an image-processing unit 83 for developing raw image data (image-capture data) captured by the image-capturing unit 81, a parameter-storing unit 84 that, for example, stores the color reproduction parameters, which are referred to in order to develop the raw image data, and a data-inputting/outputting unit 82 for sending data to and receiving data from the PC 70. The individual components of the digital camera 80 are connected to one another through a bus. In addition, the digital camera 80 includes a display unit 85 and is capable of displaying an image during shooting of the image.

The image-capturing unit 81 is configured using an optical system such as one including a photographic lens and an aperture and an imaging sensor such as a charge coupled device (CCD). The image-capturing unit 81 subjects analogue data, which corresponds to the brightness level of a subject being photographed which is focused onto the light-receiving surface of the CCD, to A/D conversion and outputs raw image data.

The data-inputting/outputting unit 82 sends data to and receives data from the PC 70, including raw image data output by the image-capturing unit 81, developed data output by the image-processing unit 83 and the color reproduction parameters referred to when the image-processing unit 83 performs color reproduction.

The parameter-storing unit 84 holds the color reproduction parameters obtained from the outside via the data-inputting/outputting unit 82. Here, a color conversion matrix (3×3 matrix) for correcting spectral characteristics of the image-capturing unit 81 and various parameters for performing white balance (WB) adjustment and auto exposure (AE) are given as examples of the color reproduction parameters. Furthermore, a 1D LUT for correcting contrast characteristics of an output image is also stored in the parameter-storing unit 84, in addition to the color reproduction parameters. There are various types of matrixes in addition to 3×3 matrixes but this embodiment is described using a 3×3 matrix as an example.

The 1D LUT is used to perform correction that improves the appearance of developed data. As examples of such correction, gamma correction of output values as gradation conversion and correction of contrast characteristics are performed using the in LUT.

The image-processing unit 83 develops a raw image by using the various parameters stored in the parameter-storing unit 84. Basically, after performing demozaic interpolation, WB adjustment, AE, matrix conversion and gamma correction on the raw image data by using the above-mentioned respective parameters, the image-processing unit 83 converts the raw image data into developed data such as Joint Photographic Experts Group (JPEG) data or tagged image file format (TIFF) data. When creating the color reproduction parameters, only the raw image data is output to the PC 70 without any processing being performed by the image-processing unit 83.

With the above-described configuration, in the digital camera 80, the image-processing unit 83 creates the developed data from the raw image data of the subject on which image capturing was performed by the image-capturing unit 81 and the data-inputting/outputting unit 82 outputs the developed data to an output device.

### 1.3 Configuration of PC

Next, the configuration of the PC 70 will be described. The PC 70 includes a data-inputting/outputting unit 71, an operation unit 72, a HDD 73 and a display unit 74. The individual components of the PC 70 are connected to one another through a bus. In addition, various software and data that the PC 70 uses to realize predetermined functions are stored in the HDD 73 and the operation unit 72 performs specific processing operations by loading the software and data into a RAM (not illustrated) and executing the software under the control of a predetermined operating system.

The data-inputting/outputting unit 71 sends or receives raw image data, developed data, color reproduction parameters, target data and the like by communicating with the digital camera 80 and the colorimeter 90. Basically, the data-inputting/outputting unit 71 performs communication through the data-inputting/outputting unit 82 of the digital camera 80. Furthermore, the data-inputting/outputting unit 71 may additionally be provided with an input device that receives inputs from a user. Examples of such an input device include a keyboard and a mouse.

A color-reproduction-parameter-creating program 73a for creating color reproduction parameters for the digital camera 80, default color reproduction parameters and the like are stored in the HDD 73. Furthermore, the operation unit 72 is configured using a CPU and a RAM, and can create color reproduction parameters by loading the color-reproduction-parameter-creating program 73a stored in the HDD 73 into the RAM and executing the color-reproduction-parameter-creating program 73a.

### 1.4 Colorimeter and Color Chart

The colorimeter 90 and the color chart 91 will now be described. The color chart 91 is configured by arranging 1˜N patches and is used with the aim of determining and analyzing the reproducibility of colors. The individual patches 1˜N cover all colors and gradations. Examples of the color chart 91 include a Munsell color chart and a Macbeth color chart. Furthermore, the colorimeter 90 subjects the individual patches 1-N of the color chart 91 to colormetry and outputs colorimetric values (X_{Ti}, Y_{Ti}, Z_{Ti}) defined using an XYZ color system (i indicates patches 1˜N). If a configuration is adopted in which colorimetric values obtained by the color chart 91 being subjected to colorimetry with the colorimeter 90 are stored in advance in the PC 70, the colorimeter 90 may be omitted from being included in the color control apparatus 100.

### 1.5 Method for Creating Color Reproduction Parameters

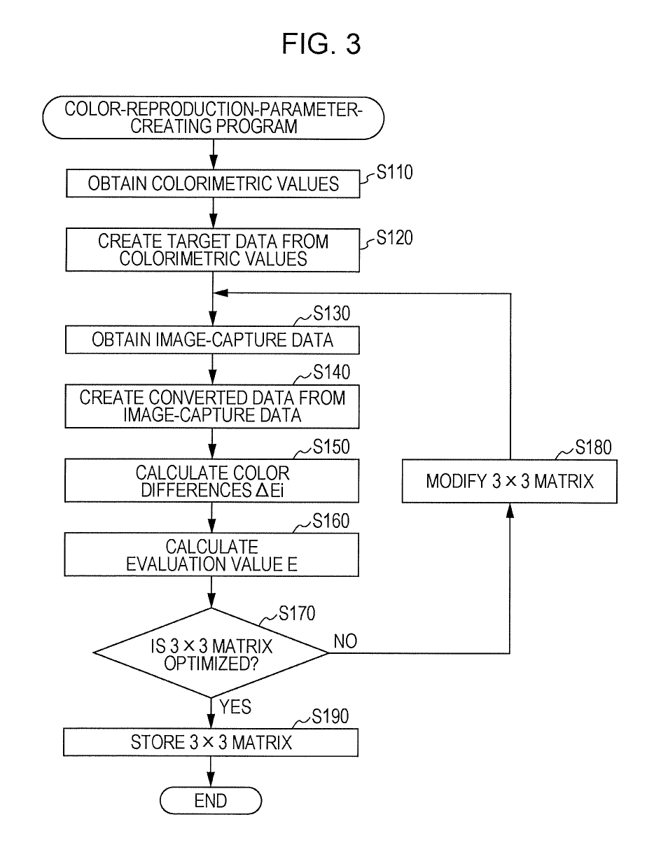

FIG. 3 is a flowchart describing processing performed by an operation unit 72 by executing a program that creates color reproduction parameters. In the flowchart illustrated in FIG. 3, a process of optimizing a 3×3 matrix for performing matrix conversion is illustrated, the 3×3 matrix being an example of the color reproduction parameters. Hereafter, the process of creating color reproduction parameters performed in the PC 70 will be described using FIG. 3.

As illustrated in FIG. 3, the processing performed by the color-reproduction-parameter-creating program 73a is broadly divided into a step of obtaining colorimetric values by subjecting the patches 1˜N to colorimetry with the colorimeter 90 (step 110), and a step of creating target data (L_{Ti}*, a_{Ti}*, b_{Ti}*) of an L*a*b* color space that has been gamma corrected (first part of conversion unit: S120); a step of obtaining output values by subjecting the color chart 91 to image capturing using the digital camera 80 (step S5130) and a step of creating converted data (L_{Pi}*, a_{Pi}*, b_{Pi}*) of the L*a*b* color space that has been gamma corrected (second part of conversion: S140); and steps of calculating color differences ΔEᵢ from the target data and the converted data and optimizing the 3×3 matrix such that an evaluation value E generated on the basis of the calculated color differences ΔEᵢ becomes small (part of conversion covered in steps S140˜S170) (i indicates patches 1˜N).

Hereafter, the process of creating the target data will be described. Upon receiving the colorimetric values (X_{Ti}, Y_{Ti}, Z_{Ti}) of the XYZ color system from the colorimeter 90 via the data-inputting/outputting unit 71 of the PC 70 (step S110), the operation unit 72 converts the colorimetric values (X_{Ti}, Y_{Ti}, Z_{Ti}) into the target data (L_{Ti}*, a_{Ti}*, b_{Ti}*) defined in the L*a*b* color space while performing gamma correction thereon (step S120).

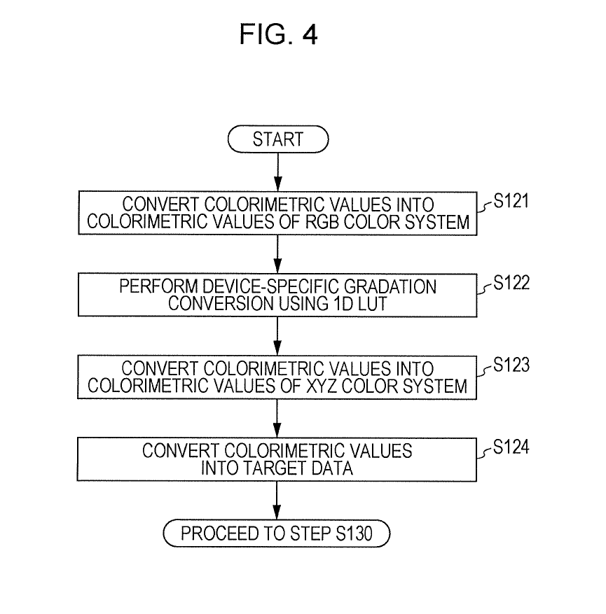

FIG. 4 is a flowchart for explaining in detail the processing performed in step S120 of FIG. 3. Upon receiving the colorimetric values (X_{Ti}, Y_{Ti}, Z_{Ti}) from the colorimeter 90, the operation unit 72 first converts the colorimetric values (X_{Ti}, Y_{Ti}, Z_{Ti}) into second colorimetric values (R_{Ti}, G_{Ti}) of an RGB color space (step S121). Basically, the operation unit 72 converts the colorimetric values of the XYZ color system into second colorimetric values of the RGB color space by using eq. 1 given below.

$$[ \begin{matrix}R \\ G \\ B\end{matrix} ] = {[ \begin{matrix}2.7689 & 1.7517 & 1.1302 \\ 1.0000 & 4.5907 & 0.0601 \\ 0.0000 & 0.0565 & 5.5943\end{matrix} ]}^{- 1} [ \begin{matrix}X \\ Y \\ Z\end{matrix} ] \qquad ( 1 )$$

Next, the operation unit 72 performs gamma correction on the calculated colorimetric values by using the 1D LUT and creates third colorimetric values (R′_{Ti}, G′_{Ti}, B′_{Ti}) (step S122). In the gamma correction performed using the 1D LUT, mainly, the contrast of the colorimetric values is adjusted in accordance with the contrast characteristics of the output apparatus such as a printer or display apparatus so that the appearance of the image is improved.

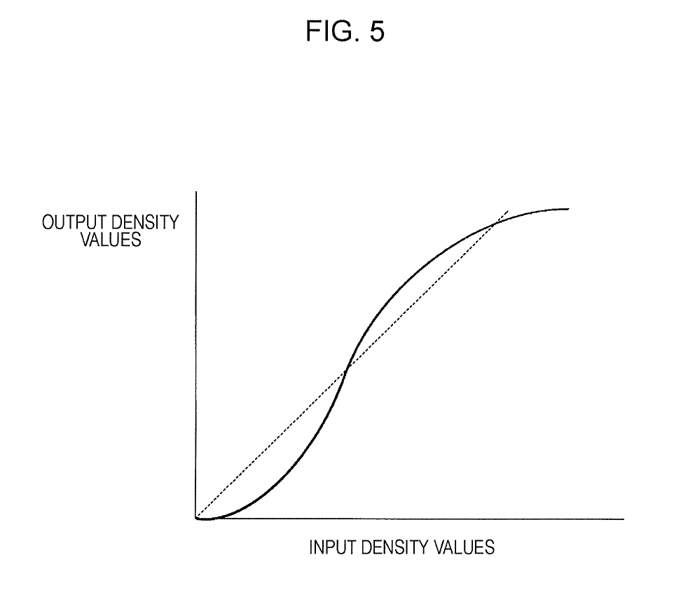

FIG. 5 is a diagram for explaining an example of contrast that has been subjected to conversion using the 1D LUT. In FIG. 5, an input/output characteristic for a value of γ of 1 is illustrated using a dotted line. The density conversion curve that is used for conversion using the 1D LUT represents a correspondence function for input and output gradation values that is nonlinear at low and high gradation values. The contrast characteristic that has undergone conversion using the 1D LUT and is illustrated in FIG. 5 is just an example, is set in accordance with output characteristics of a device connected to the digital camera 80 and design concepts that differ from manufacturer to manufacturer and is not limited to this one example.

The operation unit 72 converts the third colorimetric values corrected in step S122 into fourth colorimetric values (X′_{Ti}, Y′_{Ti}, Z′_{Ti}) that are defined in the XYZ color system (step S123). Basically, the operation unit 72 converts the third colorimetric values (R′_{Ti}, G′_{Ti}, B′_{Ti}) of the RGB color space into the fourth colorimetric values (X′_{Ti}, Y′_{Ti}, Z′_{Ti}) defined in the XYZ color system by using eq. 2 given below.

$$[ \begin{matrix}X \\ Y \\ Z\end{matrix} ] = [ \begin{matrix}2.7689 & 1.7517 & 1.1302 \\ 1.0000 & 4.5907 & 0.0601 \\ 0.0000 & 0.0565 & 5.5943\end{matrix} ] [ \begin{matrix}R \\ G \\ B\end{matrix} ] \qquad ( 2 )$$

The operation unit 72 converts the converted colorimetric values into target data defined using the L*a*b* color space (step S124). Basically, the operation unit 72 converts the colorimetric values of the XYZ color system into the target data (L_{Ti}*, a_{Ti}*, b_{Ti}*) defined using the L*a*b* color space using eq. 3 given below.

$$\begin{matrix}{L}^{*} = 116 {( \frac{Y}{{Y}_{n}} )}^{\frac{1}{3}} - 16 & Y / {Y}_{n} > 0.008856 \\ {L}^{*} = 903.29 ( \frac{Y}{{Y}_{n}} ) & Y / {Y}_{n} \leq 0.008856\end{matrix} \\ {a}^{*} = 500 ( {( \frac{X}{{X}_{n}} )}^{\frac{1}{3}} - {( \frac{Y}{{Y}_{n}} )}^{\frac{1}{3}} ) \\ {b}^{*} = 200 ( {( \frac{Y}{{Y}_{n}} )}^{\frac{1}{3}} - {( \frac{Z}{{Z}_{n}} )}^{\frac{1}{3}} ) \qquad ( 3 )$$

Here, Xₙ, Yₙ, and Zₙ are coordinates of the white point in the XYZ color system.

The operation unit 72 performs steps S121˜S124 for all of the patches 1˜N arranged in the color chart 91 and creates target data (L_{Ti}*, a_{Ti}*, b_{Ti}*) corresponding to each of the patches 1˜N. The process of creating the target data defined in the L*a*b* color space has been described above. The created target data is stored in the RAM or the like.

Next, the process of creating the converted data will be described. Upon receiving the output values (R_{Pi}, G_{Pi}, B_{Pi}), which were output by the digital camera 80 after subjecting the color chart 91 to image capturing, from the data-inputting/outputting unit 71 (step S130), the operation unit 72 creates converted data (L_{Pi}*, a_{Pi}*, b_{Pi}*) defined in the L*a*b* color space from the output values (step S140).

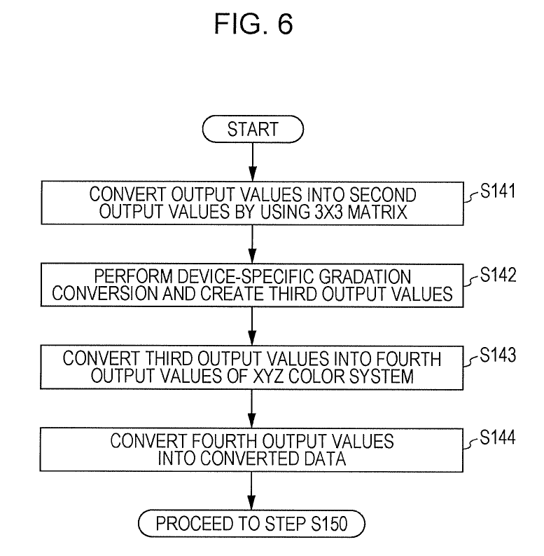

FIG. 6 is a flowchart for describing in more detail the processing performed by the operation unit 72 in step S140 of FIG. 3. The operation unit 72 converts the output values (R_{Pi}, G_{Pi}, B_{Pi}) into second output values (R′_{Pi}, G′_{Pi}, B′_{Pi}) (step S141) by using a default 3×3 matrix in order to correct the spectral characteristics of the image-capturing unit 81. Here, the default 3×3 matrix is one that performs calculations using the least squares method.

Furthermore, the operation unit 72 performs gamma correction on the second output values by using a 1D LUT and creates third output values (R″_{Pi}, G″_{Pi}, B″_{Pi}) (step S142). The 1D LUT used here is the same as that used for the colorimetric values in step S122 and is the same as that used when performing development processing on the raw image data in the digital camera 80.

The operation unit 72 converts the third output values (R″_{Pi}, G″_{Pi}, B″_{Pi}) of the RGB color space into fourth output values (X_{Pi}, Y_{Pi}, Z_{Pi}) of the XYZ color system (step S143). Basically, the operation unit 72 converts the third output values of the RGB color space into fourth output values (X_{Pi}, Y_{Pi}, Z_{Pi}) of the XYZ color system by using eq. 2 given above.

The operation unit 72 converts the fourth output values into converted data (L_{Pi}*, a_{Pi}*, b_{Pi}*) defined in the L*a*b* color space (step S144). Basically, the operation unit 72 converts the output values into converted data (L_{Pi}*, a_{Pi}*, b_{Pi}*) by using eq. 3 given above.

The operation unit 72 performs steps S141˜S144 for all of the patches 1˜N arranged in the color chart 91 and creates converted data that corresponds to the individual patches 1˜N. The process of creating converted data defined in the L*a*b* color space has been described above.

The process of optimizing the color reproduction parameters (3×3 matrix) by using the target data and the converted data will now be described. The operation unit 72 calculates color differences ΔEi between the target data (L_{Ti}*, a_{Ti}*, b_{Ti}*) and the converted data (L_{Pi}*, a_{Pi}*, b_{Pi}*) (step S150). Here, the color differences ΔEi quantitatively express perceived differences in color and are calculated in the L*a*b* color space by using eq. 4 given below.

ΔEᵢ=\sqrt{(ΔL*)²+(Δa*)²+(Δb*)²} (4)

The operation unit 72 creates an evaluation value E on the basis of the calculated color differences ΔEi (step S160). The evaluation value E is a value obtained by adding together the color differences ΔEi for all the patches 1˜N in the color chart 91 and is calculated by using eq. 5 given below.

$$E = {\sum }_{N} Δ {E}_{i} \qquad ( 5 )$$

The operation unit 72 performs optimization of the 3×3 matrix such that the evaluation value calculated in step S160 is minimized (steps S170 and S180). Basically, in the case in which the calculated evaluation value E is smaller than the previous evaluation value, the operation unit 72 adds correction values to respective values of the default 3×3 matrix and performs conversion on the 3×3 matrix, and then recalculates the evaluation value E by using the corrected 3×3 matrix (steps S130˜S180). The continuous process from step S130 to step S180 is repeatedly performed until it is determined in step S170 that the evaluation value E has been minimized and the values of the 3×3 matrix at this time are optimum values. The process may be repeated until it is determined in step S170 that the evaluation value has become equal to or less than a predetermined threshold value E_{TH}.

As an example of the method of finding correction values for the 3×3 matrix, the operation unit 72 converts the 3×3 matrix by using the Newton-Raphson method. Optimizing the 3×3 matrix using the Newton-Raphson method such that the evaluation value E is minimized is but one example and the false position method, a simplex method or the like may be used as the optimization method.

In the case where it is determined in step S170 that the 3×3 matrix has been optimized, the operation unit 70 stores the optimized 3×3 matrix in the RAM or the like and then outputs the optimized 3×3 matrix to the digital camera 80 through the data-inputting/outputting unit 71 (step S190). The digital camera 80 receives the optimized 3×3 matrix through the data-inputting/outputting unit 82 and stores the optimized 3×3 matrix in the parameter-storing unit 84.

Accordingly, the digital camera 80 subjects raw image data to development processing by using the 3×3 matrix and the 1D LUT used in step 5142. The process of creating the color reproduction parameters according to the first embodiment of the invention has been described above.

### 2. Second Embodiment

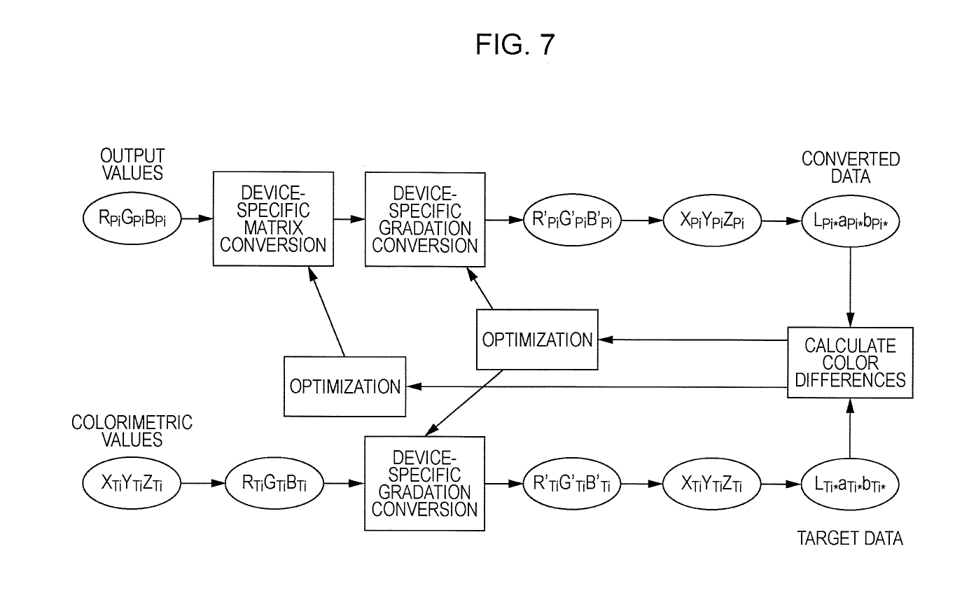

FIG. 7 is an image for explaining a method of creating color reproduction parameters according to a second embodiment. In the method of creating color reproduction parameters according to the second embodiment, in addition to the 3×3 matrix, the 1D LUT is also optimized by using the target data (L_{Ti}*, a_{Ti}*, b_{Ti*) and the converted data (L}_{Pi}*, a_{Pi}*, b_{Pi}*). Consequently, the color reproduction parameters and the 1D LUT can be optimized with greater flexibility.

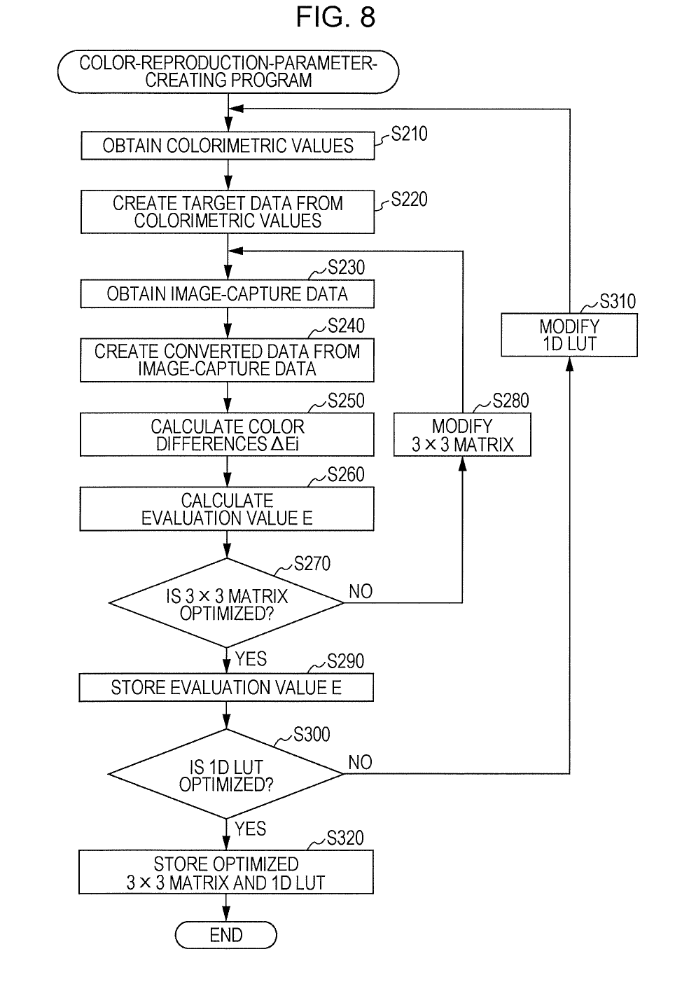

FIG. 8 is a flowchart explaining processing performed by the operation unit 72 by using a color-reproduction-parameter-creating program 73a according to the second embodiment. In the second embodiment, only the color-reproduction-parameter-creating program 73a is different and the rest of the configuration of the color control apparatus 100 is the same as that of the first embodiment.

Upon receiving colorimetric values (X_{Ti}, Y_{Ti}, a_{Ti}) of the XYZ color space from the colorimeter 90 through the data-inputting/outputting unit 71 of the PC 70 (step S210), the operation unit 72 creates target data (L_{Ti}*, a_{Ti}*, b_{Ti}*) defined in the L*a*b* color space (step S220). At this time, the operation unit 72 performs gamma correction on the colorimetric values by using a default 1D LUT. Here, the default 1D LUT is a 1D LUT that has been optimized in advance by the operation unit 72.

Next, upon receiving output values (R_{Pi}, G_{Pi}, B_{Pi}) through the data-inputting/outputting unit 71 (step S230), the output values having been output by the digital camera 80 after the digital camera 80 had performed image capturing on the color chart 91, the operation unit 72 converts the output values (R_{Pi}, G_{Pi}, B_{Pi}) into converted data (L_{Pi}*, a_{Pi}*, b_{Pi}*) defined in the L*a*b* color space (step S240) after performing gamma correction thereon using a default matrix and the default 1D LUT.

The operation unit 72 calculates color differences ΔEᵢ between the target data (L_{Ti}*, a_{Ti}*, b_{Ti}*) and the converted data (L_{Pi}*, a_{Pi}*, b_{Pi}*) (step S250). Similarly, the operation unit 72 calculates an evaluation value E by adding together the color differences ΔEi for all of the patches 1˜N of the color chart 91 (step S260). In addition, the operation unit 72 performs optimization of the 3×3 matrix such that the calculated evaluation value E is minimized by using the default in LUT (steps S270 and S280). The evaluation value E may be subjected to optimization such that it becomes equal to or less than a predetermined threshold value E_{TH1}.

In step S270, in the case where it is determined that the 3×3 matrix has been optimized, the operation unit 72 temporarily stores the optimized 3×3 matrix and the evaluation value E at this time in the RAM or the like (step S290).

Furthermore, the operation unit 72 modifies each parameter of the 1D LUT (step S310) and performs optimization on the 3×3 matrix once more such that the brightnesses of values converted by the 1D LUT are changed. For example, the operation unit 72 multiplies the colorimetric values and the output values by a predetermined gain g in the 1D LUT and the change in brightness is made greater. It is desirable that the 1D LUT be optimized in such a way that, in a low and medium brightness region, the colorimetric values and the output values are multiplied by the gain g, in a high brightness region, changes in brightness are controlled nonlinearly, and, in the vicinity of high brightness for colorimetric values and input values, white overexposure does not arise.

In addition, the operation unit 72 returns to step S210 and creates target data and converted data by using the modified 1D LUT and then performs optimization on the 3×3 matrix by using the created target data and the converted data such that the evaluation value E is minimized (steps S210˜S290). The evaluation value E may be optimized so as to be equal to or less than a predetermined threshold value E_{TH2}. Then, when it is determined that the 3×3 matrix has been optimized using the modified 1D LUT, the operation unit 72 modifies the 1D LUT again and repeats the processing of steps S210˜S310.

The processing of steps S210˜S310 described above is performed until modification of the 1D LUT using all the values of the gain g set in advance, is complete, and at the point in time when the processing has been performed using all of the values of the gain g, the operation unit 72 stores the combination of the 3×3 matrix and the 1D LUT that minimizes the evaluation value E in the RAM or the like (step S320).

Subsequently, the optimized 3×3 matrix and 1D LUT are output to the digital camera 80. The digital camera 80 receives the optimized 3×3 matrix and 1D LUT through the data-inputting/outputting unit 82 and stores the optimized 3×3 matrix and 1D LUT in the parameter-storing unit 84. Accordingly, the digital camera 80 performs development processing on raw image data, the development processing including conversion processing using the optimized 3×3 matrix and 1D LUT. The process of creating the color reproduction parameters according to the second embodiment has been described above.

### 3. Other Embodiments

In the case where a 3D LUT is used instead of the combination of a 3×3 matrix and a 1D LUT, the 3D LUT may be optimized.

In addition, the order in which the 3×3 matrix and the 1D LUT are used is not limited to the above-described order and correction of the 1D LUT may be performed first, followed by the use of the 3×3 matrix for development processing.

The color spaces to be used are also not limited to those used in the above-described embodiments and other color spaces such as L*u*v* and HLS color spaces may be used.

In addition, a PC was described as an example of the apparatus that creates the color reproduction parameters, but a display apparatus such as a smart viewer may be used as the apparatus that creates the color reproduction parameters. Furthermore, a smart viewer may be used as the color reproduction apparatus.

It goes without saying that embodiments of the invention are not limited to those described above. That is, although not disclosed in the above embodiments, the scope of the invention includes the changing or adoption of components, configurations and appropriate combinations thereof that can replace those disclosed in the above-described embodiment and the changing of calculations to mathematically equivalent calculations; the appropriate substitution and adoption of components, configurations and combinations thereof of known technologies that can replace those disclosed in the above-described embodiments; and the appropriate substitution and adoption of components, configurations and combinations thereof that those skilled in the art can conceive of to replace those disclosed in the above-described embodiments.

The entire disclosure of Japanese Patent Application No. 2009-070691, filed Mar. 23, 2009 is incorporated by reference herein.

The entire disclosure of Japanese Patent Application No. 2009-070692, filed Mar. 23, 2009 is incorporated by reference herein.

What is claimed is:

1. A color control apparatus comprising:
an image-capture-data-obtaining unit that obtains image-capture data for a predetermined target by subjecting the predetermined target to image capturing;
a colorimetric-data-obtaining unit that obtains colorimetric data for the predetermined target by subjecting the predetermined target to colorimetry;
a first conversion unit that performs a first conversion including gradation conversion on the image-capture data and obtains first color data of a predetermined color space;
a second conversion unit that performs a second conversion including gradation conversion on the colorimetric data and obtains second color data of the predetermined color space; and
a modifying unit that, on the basis of the first color data and the second color data, performs optimization of the first conversion performed by the first conversion unit;
wherein, in a case where it is determined that the first conversion, which has been modified, is not yet optimized, the modifying unit repeatedly performs a process of modifying the same first conversion and obtaining the first color data from the first conversion unit a plurality of times by using the modified first conversion until the first conversion is optimized.

2. The color control apparatus according to claim 1, wherein the same gradation conversion is performed by the first and second conversion units.

3. The color control apparatus according to claim 1, wherein the modifying unit performs optimization of processing of correcting spectral characteristics in the first conversion.

4. The color control apparatus according to claim 1, wherein the modifying unit performs optimization of the gradation conversion.

5. The color control apparatus according to claim 1, wherein the modifying unit performs optimization of the first conversion such that color differences between the first color data and the second color data are minimized.

6. A method for creating a color control system comprising:
obtaining image-capture data of a predetermined target by subjecting the predetermined target to image capturing;
obtaining calorimetric data of the predetermined target by subjecting the predetermined target to colorimetry;
performing a first conversion including gradation conversion on the image-capture data and obtaining first color data of a predetermined color space;
performing a second conversion including gradation conversion on the colorimetric data and obtaining second color data of a predetermined color space; and
performing modification of the first conversion by subjecting the first conversion to optimization on the basis of the first color data and the second color data;
wherein, in the case where it is determined that the first conversion, on which modification has been performed, is not yet optimized, in the modification, a process of modifying the first conversion and obtaining the first color data in the first conversion by using the modified first conversion is repeatedly performed a plurality of times until the first conversion is optimized.

7. A method of creating color-reproduction-apparatus for manufacturing a color reproduction apparatus that performs color reproduction on input data, the method including:
obtaining image-capture data for a predetermined target by subjecting the predetermined target to image capturing;
obtaining colorimetric data for the predetermined target by subjecting the predetermined target to colorimetry;
performing a first conversion including gradation conversion on the image-capture data and obtains first color data of a predetermined color space;
performing a second conversion including gradation conversion on the colorimetric data and obtains second color data of the predetermined color space;
performing optimization of the first conversion on the basis of the first color data and the second color data; and
inputting the optimized first conversion to the color reproducing device;
wherein, in a case where it is determined that the first conversion, which has been modified, is not yet optimized, the modifying unit repeatedly performs a process of modifying the same first conversion and obtaining the first color data from the first conversion unit a plurality of times by using the modified first conversion until the first conversion is optimized.
